(19) United States
(12) Patent Application Publication
(10) Pub. No.: US 2026/0150865 A1
(43) Pub. Date: Jun. 4, 2026

(54) ANTHOCYANIN-CONTAINING BEVERAGE

(71) Applicant: SUNTORY HOLDINGS LIMITED, Osaka (JP)

(72) Inventors: Ryota Miyanari, Kanagawa (JP); Rino Hihara, Kanagawa (JP); Masashi Itoh, Kanagawa (JP); Shinya Fukizawa, Kanagawa (JP)

(73) Assignee: SUNTORY HOLDINGS LIMITED, Osaka (JP)

(21) Appl. No.: 19/401,834

(22) Filed: Nov. 26, 2025

(30) Foreign Application Priority Data
Nov. 29, 2024 (JP) 2024-208277

(51) Int. Cl. A23L 2/58; A23L 5/43

(52) U.S. Cl. CPC A23L 2/58; A23L 5/43

(57) ABSTRACT

The beverage contains an anthocyanin. A copper ion is blended into the beverage containing the anthocyanin. When a copper ion content is “B” ppm and an anthocyanin content is “A” ppm, a ratio of B/A, is adjusted to 0.000003 or more. It was found that an effect of photodegradation of the anthocyanin can be suppressed.

### TECHNICAL FIELD

The present invention relates to a beverage containing anthocyanin, a method for producing the same, a method for suppressing degradation of anthocyanin, and the like.

### BACKGROUND ART

Anthocyanins, which are pigments widely distributed throughout the plant kingdom, have long been used as colorants in foods. In recent years, anthocyanins have attracted attention as components having functions other than coloring, such as an antioxidant effect, an eye strain reducing effect, a night vision improving effect, a peripheral blood flow improving effect, and a body fat accumulation suppressing effect.

On the other hand, anthocyanins are generally known to have poor light resistance and to be discolored by photodegradation (Patent Document 1). In this regard, it has been reported that discoloration of chlorophyll can be suppressed by adjusting the content ratio of a copper ion and a zinc ion in a beverage containing chlorophyll (Patent Document 2). It has also been reported that in the production of a green juice beverage, the vivid green color of the green juice beverage can be maintained by adding a metal ion and adjusting the pH to a certain range before sterilization (Patent Document 3). However, while anthocyanin is a type of polyphenol, chlorophyll has a structure in which phytol (long-chain alcohol) is ester-bonded to tetrapyrrole, and the chemical structures of both are completely different. Therefore, the findings obtained in chlorophyll cannot be applied to anthocyanins.

### CITATION LIST

### Patent Document

Patent Document 1: JP 2021-159056 A
Patent Document 2: JP 2020-156430 A
Patent Document 3: JP 2009-165439 A

### SUMMARY OF INVENTION

### Technical Problem

An object of the present invention is to suppress photodegradation of an anthocyanin in a beverage containing the anthocyanin.

### Solution to Problem

To solve the above-described issues, the present inventors have conducted intensive studies using various metal ions, and as a result, they have found that, by blending a copper ion into a beverage containing an anthocyanin, and adjusting B/A, a ratio of a copper ion content (“B” in ppm) to an anthocyanin content (“A” in ppm), to 0.000003 or more. Furthermore, the present inventors have also found that the effect of suppressing the photodegradation of an anthocyanin is further improved by adjusting the anthocyanin content and the copper ion content to predetermined ranges.

That is, the present invention relates to the following, but is not limited thereto.
(1) A beverage, containing an anthocyanin and a copper ion, the beverage having B/A, a ratio of a copper ion content (“B” in ppm) to an anthocyanin content (“A” in ppm), of 0.000003 or more.
(2) The beverage according to (1), wherein the copper ion content is from 0.001 to 1 ppm.
(3) The beverage according to (1) or (2), wherein the anthocyanin content is from 0.25 to 300 ppm.
(4) The beverage according to any of (1) to (3), wherein a pH is 6 or less.
(5) The beverage according to any of (1) to (4), wherein the copper ion is contained as a copper salt or copper yeast.
(6) The beverage according to (5), wherein the copper salt is copper sulfate or copper gluconate.
(7) The beverage according to any of (1) to (6), which is a beverage packaged in a transparent container.
(8) A method for producing a beverage containing an anthocyanin, the method including blending an anthocyanin and a copper ion into a beverage, wherein
B/A, a ratio of a copper ion content (“B” in ppm) to an anthocyanin content (“A” in ppm) in the beverage, is 0.000003 or more.
(9) A method for suppressing degradation of an anthocyanin in a beverage, the method including blending an anthocyanin and a copper ion into a beverage, wherein
B/A, a ratio of a copper ion content (“B” in ppm) to an anthocyanin content (“A” in ppm) in the beverage, is 0.000003 or more.

### Advantageous Effects of Invention

According to the present invention, it is possible to provide a beverage containing an anthocyanin in which the photodegradation of the anthocyanin is suppressed. That is, the present invention can provide a beverage in which an anthocyanin is stably retained for a long period of time.

### DESCRIPTION OF EMBODIMENTS

Unless otherwise noted, “ppm” used in the present specification means ppm by weight/volume (w/v).

### 1. Beverage Containing Anthocyanin

In one aspect, the present invention is a beverage containing an anthocyanin and a copper ion, in which

B/A, a ratio of a copper ion content (“B” in ppm) to an anthocyanin content (“A” in ppm), is 0.000003 or more. The photodegradation of an anthocyanin can be suppressed by blending a copper ion into a beverage containing an anthocyanin and adjusting B/A, a ratio of the copper ion content (“B” in ppm) to the anthocyanin content (“A” in ppm), to 0.000003 or more.

### (1) Anthocyanin

An anthocyanin is a kind of polyphenol and a natural pigment component that is abundantly contained in a grape, a blueberry, a blackcurrant, an eggplant, a purple sweet potato, a black bean, red wine, and the like. Anthocyanins have long been used for coloring foods but have recently attracted attention because of their functions such as an antioxidant effect, an eye strain reducing effect, a night vision improving effect, a peripheral blood flow improving effect, and a body fat accumulation suppressing effect. Anthocyanin is a generic term for glycosides in which a sugar is bonded to anthocyanidin which is an aglycone. As anthocyanidins, 6 species of delphinidin, cyanidin, malvidin, peonidin, petunidin, and pelargonidin are mainly known, most of which exist as glycosides (anthocyanins) in plants. The type of the attached sugars is mainly monosaccharides such as glucose, galactose, arabinose, rhamnose, and xylose, but also includes conjugates of disaccharides and trisaccharides. There are also acylated anthocyanins in which one or more organic acids are ester-bonded to the sugar moiety, and examples of the type of organic acid include aliphatic organic acids (acetic acid, malonic acid, etc.) and aromatic organic acids (p-coumaric acid, caffeic acid, ferulic acid, etc.). In the present specification, the term “anthocyanin” is a generic term for various anthocyanins, and refers to a substance containing a part or all of anthocyanins.

The upper limit of the anthocyanin content contained in the beverage of the present invention is not particularly limited, and is, for example, 300 ppm, 250 ppm, 200 ppm, 150 ppm, 100 ppm, 75 ppm, 50 ppm, or 30 ppm. The lower limit of the anthocyanin content contained in the beverage of the present invention is not particularly limited, and is, for example, 0.25 ppm, 0.5 ppm, 0.75 ppm, 1 ppm, 2 ppm, or 3 ppm. Furthermore, a range for the anthocyanin content in the beverage of the present invention is not particularly limited, and is, for example, from 0.25 to 300 ppm, from 0.5 to 250 ppm, from 0.75 to 200 ppm, from 1 to 150 ppm, from 2 to 100 ppm, from 3 to 75 ppm, from 3 to 50 ppm, or from 4 to 30 ppm. When the anthocyanin content falls within this range, the effect of suppressing the photodegradation of an anthocyanin can be further improved by blending a certain amount of copper ions.

In producing the beverage of the present invention, a purified or isolated anthocyanin may be used, a raw material containing an anthocyanin may be used, or both of them may be used. Examples of the raw material containing an anthocyanin include plant extracts of grapes, blueberries, blackcurrants, eggplant, purple sweet potatoes, black beans, and purple carrots, and red wine. In the case of using the raw material in the present invention, such a raw material may be used singly, or two or more thereof may be used in combination.

The anthocyanin content can be measured by an HPLC method, an LC-MS method, an LC-MS/MS method, an absorbance method, a pH differential method (AOAC 2005.02. 2005. Horwitz W. ed., Official Methods of Analysis of AOAC International, 18th Ed. AOAC Int., Gaithersburg, MD), or the like, and is preferably measured by an HPLC method. For example, the anthocyanin content can be determined by measuring the total amount of the anthocyanin using cyanidin-3-glucoside as an index according to the method of Cassinese et al. (Journal of AOAC International Vol. 90, No. 4, 911-919, 2007). In this example, the total area of 525 nm obtained by the HPLC method was calculated as the cyanidin-3-glucoside equivalent. That is, in the present invention, the anthocyanin content means a measured value using cyanidin-3-glucoside as an index.

### (2) Copper Ion

The upper limit of the copper ion content contained in the beverage of the present invention is not particularly limited, and is, for example, 10 ppm, 5 ppm, 1 ppm, 0.5 ppm, or 0.25 ppm. The lower limit of the copper ion content contained in the beverage of the present invention is not particularly limited, and is, for example, 0.001 ppm, 0.0025 ppm, 0.005 ppm, 0.01 ppm, 0.015 ppm, or 0.025 ppm. Furthermore, a range for the copper ion content in the beverage of the present invention is not particularly limited, and is, for example, from 0.001 to 10 ppm, from 0.0025 to 5 ppm, from 0.01 to 1 ppm, from 0.015 to 0.5 ppm, or from 0.015 to 0.25 ppm. When the copper ion content falls within this range, the effect of suppressing the photodegradation of an anthocyanin can be further improved.

In the production of the beverage of the present invention, the copper ion may be derived from a raw material containing an anthocyanin or may be added separately. To adjust the copper ion content to the aforementioned range, a copper salt or copper yeast that can be blended into the beverage may be added. Examples of the copper salt include copper sulfate and copper gluconate. Examples of the copper yeast include yeast into which copper is incorporated. In one aspect, the copper ion in the beverage of the present invention is derived from a copper salt or copper yeast. In the beverage of the present invention, the copper ion may be present in a state of being free from the copper salt or copper yeast or present in a non-free state.

The method of measuring the copper ion content is not particularly limited, and a known measurement method can be used. For example, the copper ion content can be measured using a colorimetric method.

In the beverage of the present invention, metal ions (for example, iron ions, zinc ions, manganese ions, calcium ions, and magnesium ions) other than copper ions may be blended, as long as the effect of suppressing the photodegradation of an anthocyanin by a copper ion is not inhibited.

(3) Ratio B/A of Copper Ion Content B (ppm) to Anthocyanin Content A (ppm)

In the beverage of the present invention, B/A, a ratio of the copper ion content (“B” in ppm) to the anthocyanin content (“A” in ppm), is 0.000003 or more. The upper limit of the ratio is not particularly limited, and is, for example, 1.0, 0.5, 0.35, 0.15, 0.035, or 0.015. The lower limit of the ratio is not particularly limited, and is, for example, 0.000008, 0.00001, 0.00003, 0.00008, 0.0001, 0.0003, 0.0008, 0.001, or 0.003. Furthermore, the range of the ratio is not particularly limited, and is, for example, from 0.000003 to 1.0, from 0.000008 to 0.5, from 0.00001 to 0.35, from 0.00003 to 0.15, from 0.00008 to 0.035, or from 0.0001 to 0.015. When the ratio falls within this range, the effect of suppressing the photodegradation of an anthocyanin can be exhibited.

(4) pH

The pH of the beverage of the present invention is not particularly limited, and is, for example, from pH 2.0 to 7.0, preferably from 3.0 to 6.0. When the pH of the beverage of the present invention is from 3.0 to 6.0, the effect of suppressing photodegradation of an anthocyanin by a copper ion can be further improved.

The pH adjustment of the beverage of the present invention is not particularly limited, and for example, organic acids such as citric acid, malic acid, lactic acid, and phosphoric acid, sodium salts such as disodium citrate, trisodium citrate, sodium hydrogen carbonate, and sodium hydroxide, and potassium salts such as potassium hydroxide and potassium carbonate can be used.

### (5) Type of Beverage

The type of the beverage of the present invention is not particularly limited, and may be an alcoholic beverage or a non-alcoholic beverage, such as a soft drink.

In the present specification, the alcoholic beverage means a beverage having an alcohol content of 1 v/v % or more, while the non-alcoholic beverage means a beverage having an alcohol content of less than 1 v/v %. In the present specification, the type of alcoholic beverage is not particularly limited, and is, for example, a spirit, a liqueur, shochu, gin, vodka, rum, a highball, a chuhai (shochu highball), a cocktail, or a sour. The alcoholic beverage in the present specification may be a carbonated beverage or a non-carbonated beverage. Furthermore, in the present specification, the alcohol content of the alcoholic beverage is not particularly limited, and is, for example, from 3 to 40 v/v %, from 5 to 35 v/v %, or from 10 to 30 v/v %.

In the present specification, examples of the non-alcoholic beverage include, but are not particularly limited to, functional beverages, nutritional beverages, soft beverages, flavored water-based beverages, sports beverages, tea-based beverages (grain tea, green tea, oolong tea, black tea, blended tea, etc.), coffee beverages, and carbonated beverages.

### (6) Container

In one aspect, a beverage of the present invention is a packaged beverage. The type of container used is not limited, but is preferably a transparent container. A beverage packaged in a transparent container is susceptible to light irradiation. Examples of the transparent container include a container having a transmittance of 40% or more, preferably 50% or more, in visible light at 700 nm. Specific examples thereof include a transparent plastic bottle and a transparent glass bottle, and a transparent PET bottle is particularly preferably used in the present invention. The color of the container is not particularly limited, but is preferably colorless.

The transparent container may be partially or entirely covered with a film or the like. For example, the transparent region is not limited, and examples thereof include a container in which a label and a printed portion for content display are opaque or translucent and other portions are transparent, a container in which a transparent portion and an opaque portion having designability are combined to be different at a plurality of portions, and an opaque container having only a transparent portion having a size of about a viewing window.

### (7) Additional Component

In the beverage of the present invention, various additives, for example, a flavoring, a vitamin, a pigment, an antioxidant, an emulsifier, a preservative, a seasoning, an extract, a pH adjusting agent, and a quality stabilizer may be blended in the same manner as in a normal beverage as long as the effect of the present invention is not impaired.

### (8) Heat Sterilization

In one aspect, the beverage of the present invention can be a packaged beverage in a sealed container, which is obtained through a heat sterilization treatment. The conditions for heat sterilization may be selected, for example, to achieve an effect equivalent to the conditions prescribed by the Food Sanitation Act, and specifically, may be set to a temperature of 60° C. to 150° C. for 1 second to 60 minutes. When a heat-resistant container (such as glass) is used as a container, retort sterilization (from 110 to 140° C., 1 to several tens of minutes) can also be performed. When a non-heat resistant container (such as a PET bottle) is used as the container, for example, the prepared liquid is sterilized in advance at a high temperature for a short time using a plate-type heat exchanger or the like (UHT sterilization: from 110 to 150° C., 1 to several tens of seconds), cooled to a certain temperature, and then filled in the container.

### 2. Method

In one aspect, the present invention is a method for producing a beverage containing an anthocyanin. Specifically, the method for producing a beverage containing an anthocyanin includes a step of blending an anthocyanin and a copper ion into a beverage, in which B/A, a ratio of a copper ion content (“B” in ppm) to an anthocyanin content (“A” in ppm) in the beverage, is 0.000003 or more.

The step(s) of adjusting the content of the components in the beverage and/or the pH of the beverage is as described above for the beverage of the present invention or self-evident from these descriptions. The timing thereof is not limited either. For example, those above-described steps may be performed simultaneously or may be performed separately, or the order of the steps may be changed. The finally obtained beverage is required to satisfy the above-described conditions. Preferred ranges of the content of the component, ratio, and pH are as described above for the beverage. The type of the beverage produced by the above-described method is also as described above for the beverage.

The beverage produced by the production method of the present invention can suppress the photodegradation of an anthocyanin. Therefore, in another aspect, the production method is a method for suppressing the photodegradation of an anthocyanin.

### EXAMPLES

Hereinafter, details of the present invention will be specifically described by presenting experimental examples, but the present invention is not limited to this. In addition, unless otherwise specified in the present specification, numerical ranges are described as including their endpoints.

In this example, the anthocyanin content in the beverage was measured using HPLC. The specific measurement method is as follows.
HPLC apparatus: Thermo vanquish UHPLC system
Column: Impact UK-C18 HT (3 mm×100 mm)
Column temperature: 40° C.
Mobile phase A: water-formic acid (99.9:0.1)
Mobile phase B: acetonitrile-formic acid (99.9:0.1)
Detection: UV 525 nm
Injection volume: 5 μL
Flow rate: 1.0 mL/min
Gradient program:

| Time (min) | % A | % B |
|---|---|---|
| 0 | 94 | 6 |
| 0.5 | 94 | 6 |
| 4.5 | 72 | 28 |
| 5.0 | 0 | 100 |
| 6.0 | 0 | 100 |
| 6.1 | 94 | 6 |
| 7.0 | 94 | 6 |

Standard substance: Cyanidin 3-glucoside chloride (Nagara Science Co., Ltd.)

### Example 1: Comparison of Various Metal Ions on Suppression of Degradation of Anthocyanin

A sample beverage (pH 3.3, 20% ethanol) containing 9 ppm of anthocyanins was prepared, and various metal ions (iron ions, zinc ions, or copper ions) were blended in the form of salts and at the concentration listed in Table 1, and the total amount was adjusted to 200 μL. Thereafter, the sample was irradiated with light (42 klx, 25° C., 24 hours), and the anthocyanin content in each sample after the irradiation was measured by the above-described analysis method. The results are listed in Table 1.

TABLE 1

| Metal ion | Iron(III) | Iron(II) | Iron | Iron(II) | Copper(II) | Copper(II) | Zinc |
|---|---|---|---|---|---|---|---|
| concentration | chloride | sulfate | acetate | gluconate | sulfate | gluconate | sulfate |
| 0 ppm | 35.2 | 34.0 | 34.1 | 34.7 | 34.4 | 36.9 | 35.8 |
| 0.01 ppm | 33.1 | 31.0 | 34.1 | 32.7 | 43.0 | 42.7 | 35.4 |
| 0.1 ppm | 22.2 | 14.9 | 17.5 | 21.7 | 69.8 | 70.4 | 35.7 |
| 1 ppm | 2.6 | 0.0 | 0.0 | 2.6 | 80.7 | 81.6 | 35.3 |

Numerical value: anthocyanin retention rate (unit: %)

As listed in Table 1, when an iron ion was added, the retention rate of anthocyanin decreased as the blending amount added increased, regardless of the type of salt form, and rather degradation was promoted. In addition, when zinc sulfate was blended as a zinc ion, the retention rate of anthocyanin was not changed. On the other hand, it was revealed that when copper sulfate or copper gluconate is blended as a copper ion, the retention rate of anthocyanin increased and photodegradation of an anthocyanin was suppressed. When other metal ions (manganese ion, aluminum ion, magnesium ion, potassium ion, sodium ion, tin ion) were used, the retention rate of anthocyanin was not changed as with the zinc ion. That is, it was revealed that the effect of suppressing the photodegradation of an anthocyanin was exhibited when copper ions were added.

### Example 2: Influence of Copper Ion on Effect of Suppressing Degradation of Anthocyanin

A citrate buffer solution (pH 3.2, containing 20% ethanol) containing an anthocyanin derived from purple carrot pigment was prepared, in which copper (II) sulfate pentahydrate as a copper ion was blended so that the content was as listed in Table 2, and the total amount was adjusted to 200 μL to prepare each sample. Thereafter, the sample was irradiated with light (42 klx, 25° C., 24 hours), and the anthocyanin content in each sample after the irradiation was measured by the above-described analysis method. The retention rate of anthocyanin was calculated for each sample, and compared with the group without copper addition (samples 1, 9, 16, 24, 32, and 40), the case where the retention rate increased by 5% or more was evaluated as having a “significant effect:”, the case where the retention rate increased by 1% or more was evaluated as having an “◯effect: Δ”, and the case where no change was observed in the retention rate was evaluated as having “no effect: x”. The results are listed in Table 2.

TABLE 2

| | 1 | 2 | 3 | 4 | 5 | 6 | 7 | 8 |
|---|---|---|---|---|---|---|---|---|
| Anthocyanin content (ppm) | 300 | 300 | 300 | 300 | 300 | 300 | 300 | 300 |
| Copper ion content (ppm) | 0 | 0.001 | 0.0025 | 0.01 | 0.025 | 0.1 | 0.25 | 1 |
| Copper ion/anthocyanin ratio | 0.000000 | 0.000003 | 0.000008 | 0.000033 | 0.000083 | 0.000333 | 0.000833 | 0.003333 |
| Anthocyanin retention rate | 56% | 57% | 59% | 59% | 62% | 74% | 81% | 85% |
| Degradation suppressing effect | — | Δ | Δ | Δ | ◯ | ◯ | ◯ | ◯ |
| | 9 | 10 | 11 | 12 | 13 | 14 | 15 | 16 |
| Anthocyanin content (ppm) | 75 | 75 | 75 | 75 | 75 | 75 | 75 | 30 |
| Copper ion content (ppm) | 0 | 0.0025 | 0.01 | 0.025 | 0.1 | 0.25 | 1 | 0 |
| Copper ion/anthocyanin ratio | 0.00000 | 0.00003 | 0.00013 | 0.00033 | 0.00133 | 0.00333 | 0.01333 | 0.00000 |
| Anthocyanin retention rate | 48% | 51% | 53% | 64% | 79% | 84% | 85% | 43% |
| Degradation suppressing effect | — | Δ | ◯ | ◯ | ◯ | ◯ | ◯ | — |

| | 17 | 18 | 19 | 20 | 21 | 22 | 23 | 24 |
|---|---|---|---|---|---|---|---|---|
| Anthocyanin content (ppm) | 30 | 30 | 30 | 30 | 30 | 30 | 30 | 7.5 |
| Copper ion content (ppm) | 0.001 | 0.0025 | 0.01 | 0.025 | 0.1 | 0.25 | 1 | 0 |
| Copper ion/anthocyanin ratio | 0.00003 | 0.00008 | 0.00033 | 0.00083 | 0.00333 | 0.00833 | 0.03333 | 0.00000 |
| Anthocyanin retention rate | 46% | 49% | 60% | 77% | 91% | 94% | 88% | 37% |
| Degradation suppressing effect | Δ | ◯ | ◯ | ◯ | ◯ | ◯ | ◯ | — |

| | 25 | 26 | 27 | 28 | 29 | 30 | 31 | 32 |
|---|---|---|---|---|---|---|---|---|
| Anthocyanin content (ppm) | 7.5 | 7.5 | 7.5 | 7.5 | 7.5 | 7.5 | 7.5 | 3 |
| Copper ion content (ppm) | 0.001 | 0.0025 | 0.01 | 0.025 | 0.1 | 0.25 | 1 | 0 |
| Copper ion/anthocyanin ratio | 0.00013 | 0.00033 | 0.00133 | 0.00333 | 0.01333 | 0.03333 | 0.13333 | 0.00000 |
| Anthocyanin retention rate | 43% | 50% | 66% | 76% | 84% | 86% | 86% | 32% |
| Degradation suppressing effect | ◯ | ◯ | ◯ | ◯ | ◯ | ◯ | ◯ | — |
| | 33 | 34 | 35 | 36 | 37 | 38 | 39 | 40 |
| Anthocyanin content (ppm) | 3 | 3 | 3 | 3 | 3 | 3 | 3 | 0.75 |
| Copper ion content (ppm) | 0.001 | 0.0025 | 0.01 | 0.025 | 0.1 | 0.25 | 1 | 0 |
| Copper ion/anthocyanin ratio | 0.00033 | 0.00083 | 0.00333 | 0.00833 | 0.03333 | 0.08333 | 0.33333 | 0.00000 |
| Anthocyanin retention rate | 44% | 55% | 74% | 84% | 95% | 92% | 96% | 18% |
| Degradation suppressing effect | ◯ | ◯ | ◯ | ◯ | ◯ | ◯ | ◯ | — |

| | 41 | 42 | 43 | 44 | 45 | 46 | 47 |
|---|---|---|---|---|---|---|---|
| Anthocyanin content (ppm) | 0.75 | 0.75 | 0.75 | 0.75 | 0.75 | 0.75 | 0.75 |
| Copper ion content (ppm) | 0.001 | 0.0025 | 0.01 | 0.025 | 0.1 | 0.25 | 1 |
| Copper ion/anthocyanin ratio | 0.00133 | 0.00333 | 0.01333 | 0.03333 | 0.13333 | 0.33333 | 1.33333 |
| Anthocyanin retention rate | 30% | 43% | 80% | 83% | 90% | 90% | 90% |
| Degradation suppressing effect | ◯ | ◯ | ◯ | ◯ | ◯ | ◯ | ◯ |

As listed in Table 2, it was revealed that, when an anthocyanin and a copper ion were blended and B/A, a ratio of the copper ion content (“B” in ppm) to the anthocyanin content (“A” in ppm), was adjusted to 0.000003 or more, the retention rate of anthocyanin was increased, while the photodegradation of the anthocyanin was suppressed regardless of the contents of the anthocyanin and the copper ion.

### Example 3: Influence of pH on Effect of Suppressing Degradation of Anthocyanin by Copper Ion

Each sample containing an anthocyanin derived from a purple carrot pigment was prepared. Specifically, a 10 mM phosphate buffer solution (containing 20% EtOH) was prepared, a 10 mM aqueous citric acid solution (containing 20% EtOH) was blended to have a pH as listed in Table 3, then an anthocyanin and copper (II) sulfate pentahydrate as a copper ion were blended to have a content as listed in Table 3, and the total amount was adjusted to 200 μL. Thereafter, each sample was irradiated with light (42 klx, 25° C., 24 hours), and the anthocyanin content in each sample after irradiation was measured by the above-described analysis method. The retention rate of anthocyanin was calculated for each sample, and compared with the group without copper addition, the case where the retention rate increased by 5% or more was evaluated as having a “significant effect: ◯”, the case where the retention rate increased by 1% or more was evaluated as having an “effect: Δ”, and the case where no change was observed in the retention rate was evaluated as having “no effect: x”. The results are listed in Table 3.

TABLE 3

| | 51 | 52 | 53 | 54 | 55 | 56 |
|---|---|---|---|---|---|---|
| Anthocyanin content (ppm) | 9 | 9 | 9 | 9 | 9 | 9 |
| Copper ion content (ppm) | 0 | 0.1 | 0 | 0.1 | 0 | 0.1 |
| Copper ion/anthocyanin ratio | 0 | 0.011 | 0 | 0.011 | 0 | 0.011 |
| pH | 3.1 | 3.1 | 3.5 | 3.5 | 3.9 | 3.9 |
| Anthocyanin retention rate | 62% | 89% | 70% | 85% | 73% | 85% |
| Degradation suppressing effect | — | ◯ | — | ◯ | — | ◯ |
| | 57 | 58 | 59 | 60 | 61 | 62 |
| Anthocyanin content (ppm) | 9 | 9 | 9 | 9 | 9 | 9 |
| Copper ion content (ppm) | 0 | 0.1 | 0 | 0.1 | 0 | 0.1 |
| Copper ion/anthocyanin ratio | 0 | 0.011 | 0 | 0.011 | 0 | 0.011 |
| pH | 4.6 | 4.6 | 5.4 | 5.4 | 5.9 | 5.9 |
| Anthocyanin retention rate | 68% | 76% | 71% | 80% | 70% | 78% |
| Degradation suppressing effect | — | ◯ | — | ◯ | — | ◯ |

As listed in Table 3, it was revealed that the retention rate of anthocyanin was increased and the photodegradation of anthocyanin was suppressed by blending copper ions regardless of the pH.

### INDUSTRIAL APPLICABILITY

The present invention provides an anthocyanin-containing beverage in which the photodegradation of an anthocyanin is suppressed. That is, the present invention relates to a novel means for providing a beverage in which anthocyanins are stably retained for a long period of time, and thus has high industrial applicability.

1. A beverage, comprising an anthocyanin and a copper ion, the beverage having B/A, a ratio of a copper ion content (“B” in ppm) to an anthocyanin content (“A” in ppm), of 0.000003 or more.

2. The beverage according to claim 1, wherein the copper ion content is from 0.001 to 1 ppm.

3. The beverage according to claim 1, wherein the anthocyanin content is from 0.25 to 300 ppm.

4. The beverage according to claim 1, wherein a pH is 6 or less.

5. The beverage according to claim 1, wherein the copper ion is derived from a copper salt or copper yeast.

6. The beverage according to claim 5, wherein the copper salt is copper sulfate or copper gluconate.

7. The beverage according to claim 1, which is a beverage packaged in a transparent container.

8. A method for producing a beverage containing an anthocyanin, the method comprising blending an anthocyanin and a copper ion into a beverage, wherein
B/A, a ratio of a copper ion content (“B” in ppm) to an anthocyanin content (“A” in ppm) in the beverage, is 0.000003 or more.

9. The method according to claim 8, wherein the beverage suppresses degradation of the anthocyanin.
